(19) United States
(12) Patent Application Publication
(10) Pub. No.: US 2007/0128080 A1
(43) Pub. Date: Jun. 7, 2007

(54) Lidded vessel

(75) Inventor: Jurgen Lohn, Klein Meckelsen (DE)

Correspondence Address: VIDAS, ARRETT & STEINKRAUS, P.A., 6109 BLUE CIRCLE DRIVE, SUITE 2000, MINNETONKA, MN, 55343-9185, US

(73) Assignee: Eppendorf AG, Hamburg (DE)

(21) Appl. No.: 11/600,493

(22) Filed: Nov. 16, 2006

(30) Foreign Application Priority Data
Dec. 1, 2005 (DE) 10 2005 058 399.7

(51) Int. Cl. B01L 3/00

(52) U.S. Cl. 422/99

(57) ABSTRACT

Lidded vessel made from resilient plastics for laboratory use with a tubular vessel which has a vessel base at one end, a vessel opening at the other end, a retaining region on the inner wall of the vessel and an insertion region between the vessel opening and the retaining region, a lid which has a lid base and a stopper on one side of the lid base and which may be inserted through the vessel opening into a sealing position in the vessel, in which a sealing region of the stopper is placed on a sealing seat on the inner wall of the vessel, and a sliding ring and a retaining ring on the periphery of the stopper, the sliding ring having a lower coefficient of sliding friction relative to the insertion region than the retaining ring has relative to the retaining region and, when mounted, slides over the insertion region and is placed in the sealed position of the retaining ring on the retaining region.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

Lidded vessels of the aforementioned type typically have a capacity of several tens of millilitres or several millilitres or less than one millilitre.

A known lidded vessel comprises a vessel and a lid with a lid base which, on one side, comprises a stopper with a sealing bead on the periphery. The lid is inserted with the hollow cylinder in the manner of a stopper into the vessel opening, in order to seal the inner wall of the vessel with the sealing bead (DE-A-19645892) the entire contents of which are incorporated herein by reference.

In the known lidded vessels, the closure force for closing the lid is high. This is because the sealing bead has to be pressed with a high surface pressure against the inner wall of the vessel in order for the lidded vessel to be securely sealed. This is, in particular, the case with regard to the use of lidded vessels for applications which are associated with the heating of specimens in the vessel. Applications are known in which, for example, the lidded vessel has to be vapour-tight and the lid should not spring open when the lidded vessel and a specimen contained therein are heated in boiling water. Applications are further known in which the lid is subjected to cyclic loads by repeated heating, for example during polymerase chain reaction.

The manual application of a high closure force subjects the user to stress and is regarded by the user as troublesome, in particular if a large number of lidded vessels have to be closed, which is the case in many applications.

Furthermore, there are lidded vessels in which the surface is modified so that fewer proteins or DNA adhere to the vessel wall or in order to achieve a low retention effect. As a result, the coefficients of sliding friction are partially undesirably reduced.

One possibility for this surface modification is the coating of the lidded vessel or the addition of additives to the plastics from which the lidded vessel is manufactured. As a result of the reduced friction, the lids of the vessels may open automatically in the hot water bath.

Proceeding therefrom, the object of the invention is to provide a lidded vessel where the closure force for closing the lid is reduced and the lid is securely sealed in the vessel.

### BRIEF SUMMARY OF THE INVENTION

Advantageous embodiments of the lidded vessel are provided in the sub-claims.

The lidded vessel made from resilient plastics for laboratory use according to the invention has a tubular vessel which has a vessel base at one end, a vessel opening at the other end, a retaining region on the inner wall of the vessel and an insertion region between the vessel opening and the retaining region, a lid which has a lid base and at least one stopper on one side of the lid base and which may be inserted through the vessel opening into a sealing position in the vessel, in which a sealing region of the stopper is placed on a sealing seat on the inner wall of the vessel, and a sliding ring and a retaining ring on the periphery of the stopper, the sliding ring having a lower coefficient of sliding friction relative to the insertion region than the retaining ring has relative to the retaining region and, when mounted, slides over the insertion region and is placed in the sealed position of the retaining ring on the retaining region.

When closing the lidded vessel, firstly the sliding ring slides over the insertion region, the force expenditure required therefor, due to the relatively low coefficient of sliding friction (also known as “coefficient of friction”) of the sliding ring being markedly reduced relative to the insertion region. The retaining ring is only placed on the retaining region at the end of the closing process. In principle, therefore, the force expenditure slightly increases but this subjects the user to very little stress, however, as a substantial proportion of the work for mounting the lid in the vessel has already been applied. Moreover, the sliding ring is able to widen the vessel slightly when forced into the insertion region, so that the retaining ring is able to be relatively easily pressed into the retaining region. If the retaining ring is placed on the retaining region, due to the high coefficient of sliding friction of the retaining ring relative to the retaining region, a secure closure of the lid in the vessel and a secure seal are achieved which are also able to withstand the stresses due to heating the vessel in the boiling water bath. Furthermore, the handling of the lidded vessel does not differ from that of a conventional lidded vessel. The size does not need to be increased. Relative to the known lidded vessel, however, it has the advantage of easier handling. Moreover, a chemically resistant design is possible. Even the opening of the lid is more user-friendly with the lidded vessel, as after breaking off the retaining ring from the retaining region, the sliding ring is able to be easily pulled out of the insertion region. Additionally, as a result of tempering and/or storage (for example when using polypropylene for the retaining ring and retaining region), the opening force may be reduced.

The sliding ring and the retaining ring may, in principle, have different diameters. According to one embodiment, the sliding ring and the retaining ring have approximately the same diameter. Successively sliding the sliding ring over the insertion region and placing the retaining ring on the retaining region is facilitated thereby.

According to one embodiment, the insertion region is gradually widened towards the vessel opening. As a result, the forcing of the sliding ring into the insertion region is promoted by the gradual increase in the pressing-in force and the uniform centering of the sliding ring. If, according to a further embodiment, the sliding ring is additionally arranged in the insertion direction behind the retaining ring, so that the sliding ring enters the insertion region in front of the retaining ring and the sliding ring has approximately the same diameter as the retaining ring, during insertion only the sliding ring slides over the insertion region rather than the retaining ring. As a result, the force expenditure for the closure of the lid is particularly low.

According to one embodiment, in the sealed position the sliding ring and retaining ring enter at least partially a receiving portion of the vessel with an internal diameter which is larger than the adjacent internal diameter of the insertion region. In the transition region between the insertion region and the receiving portion the retaining ring and/or sliding ring may additionally be axially supported, whereby additional securing and/or snapping-on of the lid to the vessel is achieved.

According to a further embodiment, an undercut of the inner wall of the vessel is present between the receiving portion and the insertion region. In this embodiment the receiving portion is, for example, cylindrical or conical. In this connection, the retaining ring or sliding ring bears, in particular, against the undercut in order to snap the lid onto the vessel.

According to a further embodiment, the receiving portion is gradually widened away from the insertion region. If the sliding ring is arranged in the mounting direction behind the retaining ring, it firstly enters the widened receiving portion, so that the pressing force is lower on the sliding ring than the pressing force on the retaining ring and the retaining ring is held more securely.

In this embodiment, the receiving portion may extend from the adjacent diameter of the insertion region. It is, however, also possible that the receiving portion which gradually widens away from the insertion region, extends from an undercut adjoining the insertion region at the rear, in the mounting direction.

According to one embodiment, the sliding ring and/or the retaining ring projects radially from the cylinder. In this connection, the sliding ring and/or retaining ring are configured as a peripheral bead on the cylinder. As a result, a defined contact pressure of the sliding ring on the insertion region and of the retaining ring-on the retaining region is promoted.

The sliding ring and retaining ring are, for example, spaced apart from one another, or arranged immediately adjacent to one another on the cylinder.

According to one embodiment, the stopper is a cylinder or a cone.

In principle, it is possible to design the stopper as a solid stopper (for example a solid cylinder). According to one embodiment, the stopper is a hollow stopper (for example a hollow cylinder). This promotes a radially resilient deformation of the sliding ring and/or retaining ring so that defined contact forces may be better maintained.

As already explained with reference to embodiments of the invention, by appropriate design and adjustment of the dimensions of the insertion region, the sliding ring and the retaining ring, it may be ensured that firstly only the sliding ring slides over the insertion region and then the retaining ring is placed on the retaining region.

According to a further embodiment, this is achieved by the sliding ring being made from a material which relaxes and/or shrinks on temperature increase and/or pressure increase and/or moisture increase and/or the retaining ring is made from a material which adopts a larger volume on temperature increase and/or pressure increase and/or moisture increase. If, when using the lidded vessel, the temperature and/or the pressure and/or the moisture increases in the interior of the vessel, the sliding ring contracts and/or the retaining ring widens, so that the retaining ring is pressed into the retaining region. This embodiment may be combined with the disclosed shape and adjustment of the dimensions for the initial sliding of the sliding ring on the insertion region and the subsequent placing of the retaining ring on the retaining region.

According to a further embodiment, an initial sliding of the sliding ring on the insertion region and subsequent placing of the retaining ring on the retaining region is promoted by the hollow stopper bearing in the sealed position against the front face against an axial stop of the inner wall of the vessel and the retaining ring being a region of the hollow stopper able to be axially compressed by further pressing-in of the lid and able to be laterally pushed outwards radially until sealingly bearing against the retaining region. Preferably, the region of the hollow stopper which may be laterally pushed outwards has a reduced wall thickness and/or is of film-like configuration, so that it may be laterally pushed outwards under axial compression of the hollow stopper. This embodiment may also be combined with one of the aforementioned embodiments which promote the initial sliding of the sliding ring onto the insertion region and the subsequent placing of the retaining ring on the retaining region.

According to one embodiment, the sliding ring and/or the insertion region carries a sliding means which reduces the coefficient of sliding friction of the sliding ring relative to the insertion region and/or the sliding ring and/or the insertion region has an outer layer made from a material, and/or consists entirely of a material, which reduces the coefficient of sliding friction of the sliding ring relative to the insertion region.

Various materials may be used to reduce the coefficient of sliding friction of the sliding ring and/or the insertion region. According to one embodiment, the sliding ring and/or the insertion region carries a fluorinated sliding means and/or an outer layer made from a fluorinated material and/or consists entirely of a fluorinated material. The fluorinated material is, for example, PTFE.

According to a further embodiment, the sliding ring and/or the insertion region carries a sliding means made from polyethylene and/or comprises an outer layer made from polyethylene and/or consists entirely of polyethylene.

According to a further embodiment, the sliding ring and/or the insertion region carries a sliding means made from PVDF and/or comprises an outer layer made from PVDF and/or consists entirely of PVDF.

A plurality of suitable materials are also considered for the lidded vessel. According to one embodiment, at least the retaining region consists of polypropylene and/or at least the retaining ring of the lid consists of polypropylene. According to one embodiment, the vessel consists entirely of polypropylene, only the sliding ring and/or the insertion region being provided with a sliding means made from a different material and/or comprises an outer layer made from a different material and/or consists entirely of a different material from polypropylene. A lidded vessel made from polypropylene is particularly advantageous with a sliding ring and/or insertion region made from polyethylene. Polyethylene is a standard material with a similar chemical resistance to polypropylene.

According to a further embodiment, the sliding ring and/or insertion region has a different colour from the remaining parts of the vessel. As a result, it may be indicated to the user that the lidded vessel requires a reduced closure force.

According to a further embodiment, the vessel consists entirely of a material reducing the coefficient of sliding friction, the retaining ring and/or the retaining region being provided with a means increasing the coefficient of sliding friction made from a different material and/or comprises an outer layer made from a different material and/or consists entirely of a different material. In this connection the vessel is, for example, such a vessel in which the surface is modified in order to allow fewer proteins or DNA to adhere to the vessel wall or to achieve a low retention effect, as disclosed above. The reduction of the coefficient of sliding friction associated therewith is compensated by the increased coefficient of sliding friction of the retaining ring and/or the retaining region. As a result, this lidded vessel is also reliably sealed, in particular even when heating in the boiling water bath.

The sealing region of the stopper and the sealing seat of the vessel may have various layouts. According to one embodiment, the sealing region of the stopper is present on the retaining ring and/or on the sliding ring and/or the sealing seat of the vessel is present on the end of the insertion region and/or in the receiving region and/or on the undercut. The retaining ring and/or sliding ring is/are thus simultaneously used as a sealing ring. With the arrangement of the sealing seat at the end of the insertion region, for example, a short cylindrical end region is present. The arrangement in the receiving region in the vicinity of the end of the insertion region and/or on the undercut, is also particularly advantageous if the retaining ring rests in this region in order to snap the lid onto the vessel.

The invention includes designs in which a lid separated from the vessel may be inserted into the vessel opening. According to one embodiment, the lid is unreleasably connected to the vessel via a film hinge.

According to a further embodiment, the lid comprises a tongue projecting laterally over the vessel, which simplifies pressing in the lid into the vessel opening and/or pressing out the lid from the vessel opening.

According to one embodiment, the lidded vessel is manufactured in a multi-injection-moulding process, at least the sliding ring being injection-moulded from a different plastics from the remaining parts of the lidded vessel. For example, the sliding ring is injection-moulded from polyethylene and the remaining parts of the lidded vessel from polypropylene.

According to one embodiment, the sliding ring is injection-moulded onto the vessel or the vessel is injection-moulded onto the sliding ring. The lidded vessel is, for example, able to be manufactured by a vessel being introduced into an injection mould for injection-moulding the sliding ring and then the sliding ring being injection-moulded or the sliding ring being introduced into an injection mould for injection-moulding the vessel and then the vessel being injection-moulded.

According to a further embodiment, the sliding ring is arranged in an annular groove or between projections on the periphery of the cylinder. As a result, the sliding ring is held unreleasably on the lid. In this connection it is possible to snap the sliding ring subsequently onto a cylinder of the lid.

### BRIEF DESCRIPTION OF THE SEVERAL VIEWS OF THE DRAWINGS

The invention is described in more detail hereinafter with reference to the accompanying drawings, in which:

FIG. 1 shows an oblique perspective view from above of a lidded vessel;

FIG. 2 shows a top view of the same lidded vessel;

FIG. 3 shows a longitudinal section of the vessel of the same lidded vessel;

FIG. 4 shows a partial section of the lid and vessel when mounting the cylinder into the vessel opening;

FIG. 5 shows a partial section of the lid and vessel in the sealed position;

FIG. 6 shows a partial section of the lid and vessel of a further lidded vessel with the sealing region on the sliding ring;

FIG. 7 shows a partial section of the lid and vessel of a further lidded vessel, in which the retaining ring is arranged in the insertion direction behind the sliding ring and comprises the sealing region.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated The lidded vessel has a vessel 1 with a shell-shaped vessel base 2, an adjacent conical portion 3 and a cylinder portion 4 adjacent thereto, which comprises a vessel opening 5 and a vessel flange 6 surrounding said opening. In the region of the vessel opening 5, the vessel 1 is reinforced by ribs 7 which are located beneath the vessel flange 6 on the outer periphery of the cylinder portion 4.

On its inner wall 8 adjacent to the vessel opening 5, the vessel 1 has a conical insertion region 9 which gradually widens towards the vessel opening 5.

In the region of the smallest diameter, the insertion region 9 has a cylindrical end region 10. The insertion region 9 is defined by an undercut 11. A receiving region 12 extends from the undercut 11 which gradually widens conically in the direction of the vessel base 2.

The approach angle of the insertion region 9 is approximately 10°. The approach angle of the receiving region 12 is approximately 1°.

Adjacent to the receiving region 12 a conical transition region 13 is present which narrows in its diameter in the direction of the vessel base 2. In the transition portion 13 the wall thickness of the vessel 1 gradually increases. From the transition portion 13 to the vessel base 2, the vessel 1 has a substantially uniform wall thickness.

The lidded vessel further has a lid 14 which comprises a lid base 15 which has the shape of two identical isosceles trapezoids which are closely placed side by side on the base line. The lid base 15 has a stabilising border 16 on the edge.

The vessel flange 6 is connected to the lid 14 via a strip hinge 17 which may be folded about a fold line 18.

The lid base 15 carries on the inside a hollow cylinder 19 which on the entire periphery is at a distance from the border 16 and projects over said border. The hollow cylinder 19 has a peripheral sliding ring 20 at the free external end. The sliding ring 20 is provided with a radius 21 towards the front face of the hollow cylinder 19. Moreover, it has a cylindrical ring portion 22.

Adjacent to the sliding ring 20, a retaining ring 23 is present which is further removed from the free end of the hollow cylinder 19. The retaining ring 23 has a further cylindrical ring portion 24 which has the same diameter as the cylindrical ring portion 22 of the sliding ring 20 and is adjacent thereto. On the other side, the retaining ring 23 runs into the hollow cylinder 19 via a further radius 25.

The lidded vessel is injection-moulded in one piece in a two-component injection-moulding process from polypropylene and polyethylene. Only the sliding ring 20 consists of polyethylene, the remaining parts of the lidded vessel consisting of polypropylene.

Relative to polypropylene, polyethylene has a more favourable coefficient of sliding friction than polypropylene relative to polypropylene.

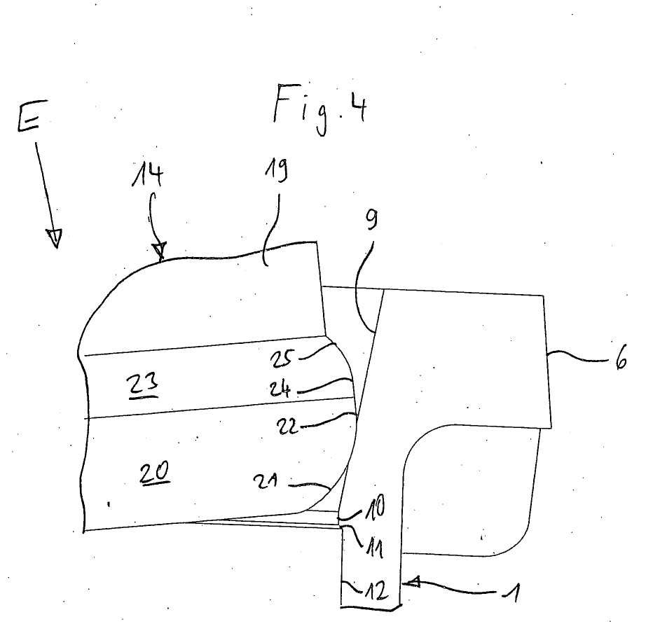

To close the lidded vessel, the lid 14 is folded in the insertion direction I about the fold line 18 so that the hollow cylinder 19 enters into the vessel opening 5. The sliding ring 20 arranged in the insertion direction I behind the retaining ring 23, therefore, slides over the conical insertion region 9. The following retaining ring 23 does not come into contact with the insertion region 9. Due to the favourable coefficient of sliding friction of the polyethylene of the sliding ring 20 relative to the polypropylene of the insertion region 9, the force expenditure required therefor is relatively low (FIG. 4).

Accordingly, the force expenditure for pushing the sliding ring 20 over the end region 10 is low. Finally, the sliding ring 20 is pushed over the undercut 11 into the receiving region 12, the retaining ring 23 being placed on the undercut 11 and the adjacent region of the receiving region 12. The latter form a retaining region 26 of the vessel 1. The force expenditure required therefor is relatively low due to the displacement path remaining short and the widening of the vessel 1 already carried out by the sliding ring 20. As the retaining ring 23 comes to bear against the retaining region 26, the lid 14 is locked to the vessel 1. At the same time, the retaining region 26 is a sealing seat 27 on which the retaining ring 23 is sealed with a sealing region 28. The retaining ring 23 is simultaneously a sealing ring.

In the locked position, the retaining ring 23 made from polypropylene is placed on the receiving region 12 and/or the undercut 11 made of polypropylene. Due to the high coefficient of sliding friction of polypropylene relative to polypropylene, the lid 14 is held securely in the vessel 1. The snapping-on produced by the bearing of the retaining ring 23 against the undercut 11, additionally secures the lid 14 in the vessel 1.

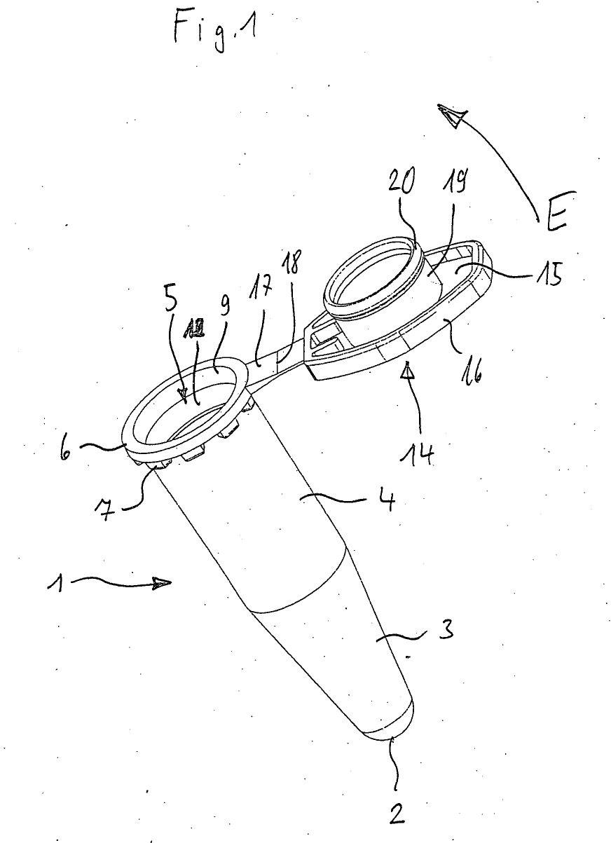

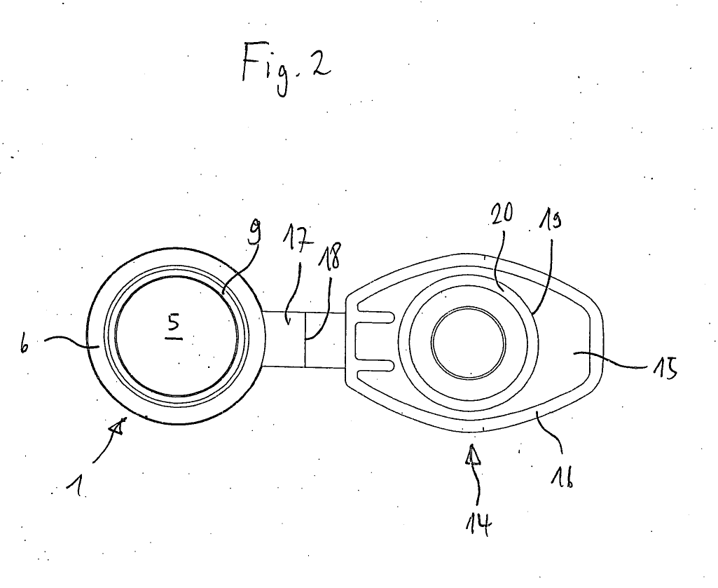

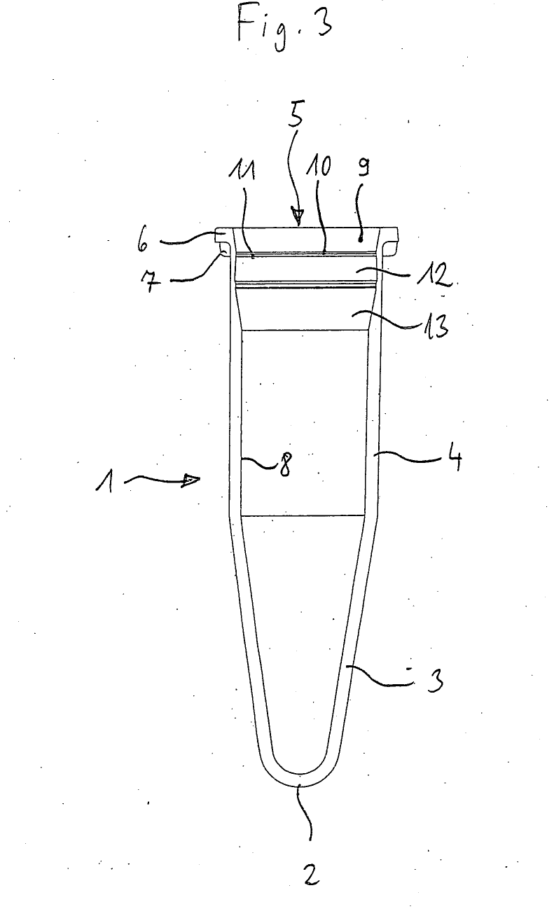

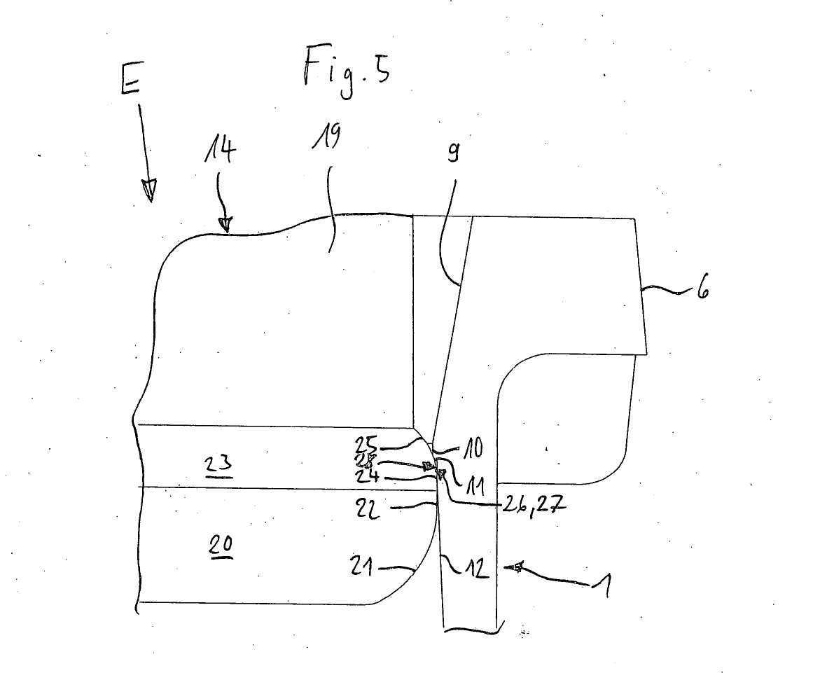

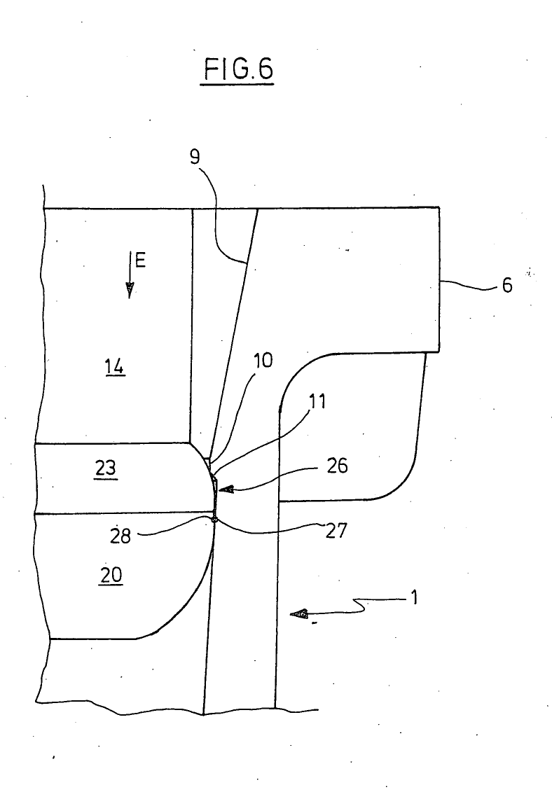

The embodiment of FIG. 6 differs from the embodiment of FIGS. 1 to 5 in that the sliding ring 20 has the sealing region 28 on the periphery and which is placed on the sealing seat 27 of the receiving region 12. To this end, the receiving region 12 tapers in the direction of the vessel base 2. The sliding ring 20, therefore, forms a sealing ring at the same time.

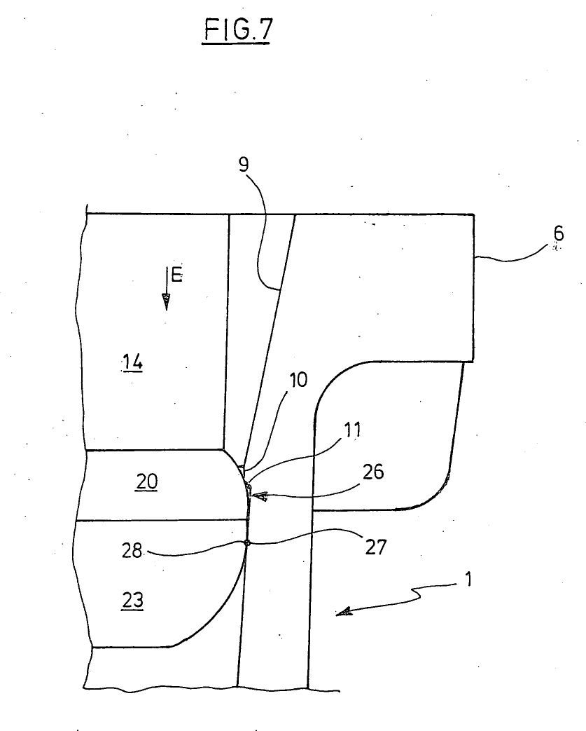

The embodiment of FIG. 7 differs from that described above in that the retaining ring 23 is arranged in the insertion direction I behind the sliding ring 20. In this case, the retaining ring 23 comprises the sealing region 28 which is placed on the sealing seat 27 of the receiving portion 12. As the sealing region 28 bears against the sealing seat 27, the lid 14 is held in the vessel 1. Additionally, the lid is secured in the vessel 1 to a certain extent by the bearing of the sliding ring 20 on the undercut 11.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. Lidded vessel made from resilient plastics for laboratory use with a tubular vessel (1) which has a vessel base (2) at one end, a vessel opening (5) at the other end, a retaining region (26) on the inner wall (8) of the vessel and an insertion region (9) between the vessel opening (5) and the retaining region (26), a lid (14) which has a lid base (18) and a stopper (19) on one side of the lid base (18) and which may be inserted through the vessel opening (5) into a sealing position in the vessel (1), in which a sealing region (28) of the stopper (19) is placed on a sealing seat (27) on the inner wall (8) of the vessel (1), and a sliding ring (20) and a retaining ring (23) on the periphery of the stopper (19), the sliding ring (20) having a lower coefficient of sliding friction relative to the insertion region (9) than the retaining ring (23) has relative to the retaining region (26) and, when mounted, slides over the insertion region (9) and is placed in the sealed position of the retaining ring (23) on the retaining region (26).

2. Lidded vessel according to claim 1, in which the sliding ring (20) has approximately the same diameter as the retaining ring (23).

3. Lidded vessel according to claim 1, in which the insertion region (9) is gradually widened towards the vessel opening (5).

4. Lidded vessel according to claim 2, in which the sliding ring (20) is arranged in the direction of insertion (I) behind the retaining ring (23).

5. Lidded vessel according to claim 1, in which in the sealed position the sliding ring (20) and the retaining ring enter at least partially a receiving portion (12) of the vessel (1) with an internal diameter which is larger than the adjacent internal diameter of the insertion region (9).

6. Lidded vessel according to claim 5, in which an undercut (11) of the inner wall (8) of the vessel is present between the receiving portion (12) and the insertion region (9).

7. Lidded vessel according to claim 5, in which the receiving portion is gradually widened away from the insertion region (9).

8. Lidded vessel according to claim 1, in which the sliding ring (20) and/or the retaining ring (23) projects radially from the stopper (19).

9. Lidded vessel according to claim 1, in which the stopper (19) is a cylinder or cone.

10. Lidded vessel according to claim 1, in which the stopper (19) is a hollow stopper.

11. Lidded vessel according to claim 1, in which the sliding ring (20) is made from a material which relaxes and/or shrinks on temperature increase and/or on pressure increase and/or on moisture increase and/or in which the retaining ring (23) is made from a material which adopts a larger volume on temperature increase and/or on pressure increase and/or on moisture increase.

12. Lidded vessel according to claim 10, in which the hollow stopper (19) bears in the sealed position on the front face against an axial stop of the inner wall (8) of the vessel (1) and the retaining ring (23) is a region of the hollow cylinder (19) able to be axially compressed by further pressing-in of the lid (14) and able to be laterally pushed outwards radially until bearing against the retaining region (26) in a fixed clamping manner.

13. Lidded vessel according to claim 12, in which the region of the hollow stopper (19) which may be laterally pushed outwards is a region of reduced wall thickness of the hollow stopper (19).

14. Lidded vessel according to claim 1, in which the sliding ring (20) and/or the insertion region (9) carries a sliding means which reduces the coefficient of sliding friction of the sliding ring (20) relative to the insertion region (9) and/or the sliding ring (20) and/or the insertion region (9) has an outer layer made from a material, and/or consists entirely of a material, which has a reduced coefficient of sliding friction relative to the insertion region (9) and/or relative to the sliding ring (20).

15. Lidded vessel according to claim 1, in which the sliding ring (20) and/or the insertion region (9) carries a fluorinated sliding means and/or comprises an outer layer made from a fluorinated material and/or consists of a fluorinated material.

16. Lidded vessel according to claim 1, in which the sliding ring (20) and/or the insertion region (9) carries a sliding means made from polyethylene and/or comprises an outer layer made from polyethylene and/or consists entirely of polyethylene.

17. Lidded vessel according to claim 1, in which the sliding ring (20) and/or the insertion region (9) carries a sliding means made from PVDF and/or comprises an outer layer made from PVDF and/or consists entirely of PVDF.

18. Lidded vessel according to claim 1, in which the sliding ring (20) and/or the insertion region (9) has a different colour from the remaining parts of the lidded vessel.

19. Lidded vessel according to claim 1, in which at least the retaining region (26) consists of polypropylene and/or in which at least the retaining ring (23) consists of polypropylene.

20. Lidded vessel according to claim 19, which consists entirely of polypropylene, the sliding ring (20) and/or the insertion region (9) being provided with a sliding means made from a different material and/or comprising an outer layer made from a different material and/or consisting entirely of a different material, the other material reducing the coefficient of sliding friction.

21. Lidded vessel according to claim 1, in which the vessel (1) consists entirely of a material reducing the coefficient of sliding friction, the retaining ring (23) and/or the retaining region (26) being provided with a means increasing the coefficient of sliding friction made from a different material and/or comprising an outer layer made from a different material increasing the coefficient of sliding friction and/or consisting entirely of a different material increasing the coefficient of sliding friction.

22. Lidded vessel according to claim 1, in which the sealing region (28) of the stopper (19) is present on the retaining ring (23) and/or on the sliding ring (20) and/or in which the sealing seat (27) of the vessel (1) is present on the end of the insertion region (9) and/or in the receiving region (12) and/or on the undercut (11).

23. Lidded vessel according to claim 1, in which the lid (14) is connected to the vessel (1) via a film hinge (17).

24. Lidded vessel according to claim 1, in which the lid (14) comprises a tongue projecting laterally over the vessel (1).

25. Lidded vessel according to claim 1, which is manufactured in a multi-injection-moulding process, at least the sliding ring (20) being injection-moulded from a different plastics from the remaining parts of the lidded vessel.

26. Lidded vessel according to claim 1, in which the sliding ring (20) is injection-moulded onto the vessel (1) or in which the vessel (1) is injection-moulded onto the sliding ring (20).

27. Lidded vessel according to claim 1, in which the sliding ring (20) is arranged in an annular groove on the periphery of the cylinder (19).
